(19) United States
(12) Patent Application Publication
(10) Pub. No.: US 2023/0148500 A1
(43) Pub. Date: May 18, 2023

(54) METHOD FOR PLANTING SUBMERGED PLANTS

(71) Applicant: Institute of Eco-environmental and Soil Sciences, Guangdong Academy of Sciences, Guangzhou (CN)

(72) Inventors: Beibei HAO, Guangzhou (CN); Haoping WU, Guangzhou (CN); Bin HE, Guangzhou (CN); Yan SUN, Guangzhou (CN); Siyi ZAHNG, Guangzhou (CN); Zhixin ZHOU, Guangzhou (CN)

(21) Appl. No.: 17/561,937

(22) Filed: Dec. 25, 2021

(30) Foreign Application Priority Data
Nov. 15, 2021 (CN) 2021113495271

(51) Int. Cl. A01G 33/00

(52) U.S. Cl. CPC A01G 33/00

(57) ABSTRACT

A method for planting submerged plants is disclosed. The method includes the steps of selecting a combination of two submerged plants; planting the combination of submerged plants; measuring a biomass and evaluating the biomass. By discussing the influence of planting proportion on the biomass of submerged plant community, the structure of submerged plant community can be optimized, and the success rate of submerged vegetation restoration and reconstruction can be improved by using the positive interaction between plant species. In addition, the submerged plants can improve the surrounding environmental conditions through positive interaction, so that the neighboring species can survive in the previously non-survivable environment, thereby increasing the species diversity of the community and constructing the submerged vegetation community structure; the positive interaction between submerged plants can promote the restoration of submerged vegetation in eutrophic lakes, and has ecological restoration effect on eutrophic waters.

### CROSS REFERENCE TO RELATED APPLICATION

This patent application claims the benefit and priority of Chinese Patent Application of No. 202111349527.1 filed on Nov. 15, 2021, the disclosure of which is incorporated by reference herein in its entirety as part of the present application.

### TECHNICAL FIELD

The present disclosure relates to the technical field of water ecological restoration, in particular to a method for planting submerged plants.

### BACKGROUND ART

Submerged plants are important primary producers and purifiers of shallow lake ecosystem, as well as regulators of water ecological balance, which has an important influence on the structure and function of lake ecosystem. Submerged plants can not only directly affect various biological processes and geochemical cycle processes in water, but also affect and regulate the community structure of different trophic levels through cascade effect, which is the basis for the maintenance of aquatic biodiversity.

However, under the influence of water eutrophication, submerged plants declined in large numbers, aquatic biodiversity disappeared, and lake ecosystem was seriously damaged. From the theoretical research and practical experience of eutrophication at home and abroad, a consensus has been reached: the restoration and reconstruction of submerged plants is a necessary link to control the eutrophication development of shallow lakes, the focus and difficulty of the current eutrophication lake management and ecological restoration, and the key to realize the transformation of lakes from “algae-type steady state” to “grass-type steady state”.

It is a very difficult task to reconstruct a large area of submerged plants in eutrophic shallow lakes. For a long time, various natural and artificial methods have been used to restore and reconstruct the submerged plants. However, in the practice of restoration, there are often violent fluctuations in which the plant community recovers rapidly and dies rapidly. So far, the success stories are still very limited.

At present, in the practice of submerged plants restoration, the main planting methods are seeding, cutting and sinking. The seeding method has low cost and is easy to work in large area, but the risk of failure is high; the survival rate of cutting method is high, but it can only be effectively implemented in shallow water area; the transplantation method can obviously improve the survival rate of plant, but it is time-consuming and costly. The practice of the restoration and reconstruction of the submerged plants indicates that the early growth of the submerged plants has an obvious effect on the early growth of the submerged plants in different planting manners, and after the roots of the plants survive and stably grow, the plant height and biomass differences are not significant. Therefore, how to improve the survival rate of submerged plants in the early stage of reconstruction so that the successfully colonized aquatic vegetation can form a self-sustaining and developing population is the primary link for rapid and effective construction of “underwater forest”.

Therefore, how to provide a method for planting submerged plants to form an effect of “plant-helping plants” in the submerged plants community and to solve the difficult problems faced by the restoration and reconstruction of the submerge plants at present, is an urgent problem for technicians in this field.

### SUMMARY

In view of the above, the present disclosure provides a method for planting submerged plants. The interaction between submerged plants species is combined with the restoration and reconstruction of submerged plants in shallow lakes for the first time, and the concept of “plant helps plant” in submerged plants communities is used to promote the growth of submerged plant communities, so as to improve the interspecific interaction and promote the ecological restoration of the growth of plant communities aiming at the submerged plants species.

In order to achieve the above purpose, the present disclosure adopts the following technical scheme:

a method for planting submerged plants, including the following steps:

(1) selecting a combination of two submerged plants;

(2) planting the combination of submerged plants;

(3) measuring a biomass and evaluating the biomass:

measuring a biomass of two submerged plants respectively, and calculating a relative yield of the species in mixed planting with a biomass of the species planted individually as reference, wherein a specific calculation method is as follows:

RY_{A}=Y_{AB}/(P_{A}×Y_{A}) \textcircled{1}

RY_{B}=Y_{BA}/(P_{B}×Y_{B}) \textcircled{2}

in the formula \textcircled{1}, RYA represents the relative yield of species A, Y_{AB} represents the biomass of species A in mixed planting of A and B, Y_{A} represents the biomass of species A in single planting, and P_{A} represents the proportion of species A in mixed planting of A and B;

in the formula \textcircled{2} RY_{B} represents the relative yield of species B, YB_{A} represents the biomass of species B in mixed planting of A and B, Y_{B} represents the biomass of species B in single planting, and P_{B} represents the proportion of species B in mixed planting of A and B;

according to the calculated relative yields of species A and B, calculating the relative yield sum RYT of the two species in mixed planting, wherein a specific calculation method is as follows:

RYT=(RY_{A}+RY_{B})/2 \textcircled{3}

if RYT is equal to 1, the interaction between the two species is not obvious;

if RYT is greater than 1, there is a positive interaction between the two species;

if RYT is less than 1, there is a negative interaction competition between the two species.

Preferably: the combination in step (1): species A is Potamogeton maackianus and species B is Myriophyllum verticillatum; the planting ratio of Myriophyllum verticillatum and Potamogeton maackianus is 1:3.

The beneficial effects are as follows: it is common in freshwater lakes or ponds, strong pollution tolerance, symbiotic, and can be propagated asexually through stem nodes.

The interaction between plant species mainly includes two aspects: competition and promotion. Wherein, interspecific promotion plays an important role in the regulation of maintaining the structure and function of plant community. The practice shows that the interspecific promotion can accelerate the restoration and formation of plant community, affect the biomass of submerged plants community and optimize the structure of submerged plant community by improving the planting proportion, and improve the survival rate of submerged plants in the early stage of reconstruction by using the promotion of plant species, so that the plants successfully colonized form a community structure that can self-maintain and develop. It is helpful to build “underwater forest” quickly and effectively.

Preferably, the planting in step (2):

1) collecting two kinds of plant materials from natural lakes and selecting tips for reserve;

2) planting the tips of species A and B in each container in a crisscross manner;

3) setting three different water eutrophication gradients for planting and cultivation.

Further: in step 1), be careful not to hurt the tip of the plant, and avoid selecting flowering plants, with the tip length of 15 cm; in step 2), the container is a small bowl (12 cm in upper diameter , height of 10 cm in height, and volume of 700 ml in volume); in step 3), the culture time is 60 d;

Preferably: laying a layer of pond mud with a thickness of 5-6 cm in the container in step 2), then inserting a lower end of the plant tip into a pond mud with a thickness of 2.8˜3.2 cm, and laying a layer of cleaned river sand with a thickness of 1.8˜2.2 cm on the pond mud after planting.

Further, the pond sediment is mixed uniformly before use.

Preferably: a planting density of both species is 130 plants/m².

Preferably: three different water eutrophication gradients in step 3) are:

moderate eutrophy TN 2.0 mg L⁻¹, TP 0.5 mg L⁻¹;

heavy eutrophy TN 4.0 mg L ⁻¹, TP 1.0 mg L ⁻¹;

ultra eutrophy TN 8.0 mg L ⁻¹, TP 2.0 L⁻¹.

The beneficial effects are as follows: under different nutrient gradients, the positive interaction between the two species is the largest and the total relative yield is the highest when the ratio of Myriophyllum verticillatum to Potamogeton microphylla is 1:3, which is the most beneficial to the community restoration and reconstruction of submerged plants in shallow lakes.

The disclosure also provides an application of the method in the restoration and reconstruction of submerged plants in shallow lakes.

As can be seen from the above technical scheme, compared with the prior art, the disclosure discloses a method for planting submerged plants, and the obtained technical effects are as follows: the structure of the submerged plant community is optimized by exploring the influence of the planting proportion on the biomass of the submerged plants community, and the success rate of the restoration and reconstruction of the submerged plant is improved by utilizing the positive interaction (promotion) effect among plant species. In addition, submerged plants can improve the surrounding environmental conditions through positive interaction, so that the neighboring species can survive in the original environment where they could not survive, thus improving the species diversity of the community and constructing the submerged vegetation community structure; the positive interaction between submerged plants can promote the restoration of submerged plants in eutrophic lakes, and has ecological restoration effect on eutrophic waters.

### BRIEF DESCRIPTION OF THE DRAWINGS

In order to more clearly explain the embodiments of the present disclosure or the technical scheme in the prior art, the follow is a brief description of the drawings required to be used in the description of the embodiment or the prior art, and it is obvious that the drawings in the following description are only embodiments of the present disclosure, and for those skilled in the art, other drawings can be obtained on the basis of the provided drawings without any creative effort.

FIG. 1 is a schematic diagram of the planting scale provided by the present disclosure.

FIG. 2 is a schematic diagram of plant planting and bottom mud laying provided by the disclosure, wherein 1—Myriophyllum verticillatum, 2—Potamogeton microphylla, 3—river sand and 4—pond mud.

FIG. 3 is a schematic diagram of an experimental arrangement design according to the present disclosure.

FIG. 4A is a comparison diagram of the relative yield sum of two species under moderate eutrophy and density ratios provided by the disclosure.

FIG. 4B is a comparison diagram of the relative yield sum of two species under heavy eutrophy and density ratios provided by the disclosure.

FIG. 4C is a comparison diagram of the relative yield sum of two species under ultra eutrophy and density ratios provided by the disclosure.

### DETAILED DESCRIPTION OF THE EMBODIMENTS

Technical schemes in embodiments of the present disclosure will be described clearly and completely below with reference to the accompanying drawings in which embodiments of the present disclosure are shown, obviously, the described embodiments are only some embodiments of the present disclosure, not all of them. Based on the embodiments in the present disclosure, all other embodiments obtained by ordinary technicians in the field without creative work are within the scope of the present disclosure.

The embodiment of the disclosure discloses a method for planting submerged plants.

### Embodiment 1

A method for planting submerged plants, including the following steps:

(1) selecting a combination of two submerged plants;

(2) planting the combination of submerged plants;

(3) measuring a biomass and evaluating the biomass:

measuring a biomass of two submerged plants respectively, and calculating a relative yield of the species in mixed planting with a biomass of the species planted individually as reference, wherein a specific calculation method is as follows:

RY_{A}=Y_{AB}/(P_{A}×Y_{A}) \textcircled{1}

RY_{B}=Y_{BA}/(P_{b}×Y_{B}) \textcircled{2}

in the formula \textcircled{1}, RYA represents the relative yield of species A, Y_{AB} represents the biomass of species A in mixed planting of A and B, Y_{A} represents the biomass of species A in single planting, and P_{A} represents the proportion of species A in mixed planting of A and B;

in the formula \textcircled{2}, RY_{B} represents the relative yield of species B, YB_{A} represents the biomass of species B in mixed planting of A and B, Y_{B} represents the biomass of species B in single planting, and P_{B} represents the proportion of species B in mixed planting of A and B;

according to the calculated relative yields of species A and B, calculating the relative yield sum RYT of the two species in mixed planting, wherein a specific calculation method is as follows:

RYT=(RY_{A}+RY_{b})/2 \textcircled{3}

if RYT is equal to 1, the interaction between the two species is not obvious;

if RYT is greater than 1, there is a positive interaction between the two species;

if RYT is less than 1, there is a negative interaction competition between the two species.

To further optimize the technical scheme: the combination in step (1): species A is Potamogeton maackianus and species B is Myriophyllum verticillatum; the planting ratio of Myriophyllum verticillatum and Potamogeton maackianus is 1:3.

To further optimize the technical scheme: the step (2) of planting includes:

1) collecting two kinds of plant materials from natural lakes and selecting tips for reserve;

2) planting the tips of species A and B in each container in a crisscross manner;

3) setting three different water eutrophication gradients for planting and cultivation.

To further optimize the technical scheme:

laying a layer of pond mud with a thickness of 5 cm in the container in step 2), then inserting a lower end of the plant tip into a pond mud with a thickness of 2.8c m, and laying a layer of cleaned river sand with a thickness of 1.8 cm on the pond mud after planting.

To further optimize the technical scheme: a planting density of both species is 130 plants/m².

To further optimize the technical scheme: three different water eutrophication gradients in step 3) are:

moderate eutrophy TN 2.0 mg L⁻¹, TP 0.5 mg L⁻¹;

heavy eutrophy TN 4.0 mg L⁻¹, TP 1.0 mg L⁻¹;

ultra eutrophy TN 8.0 mg L⁻¹, TP 2.0 L⁻¹.

### Embodiment 2

A method for planting submerged plants, including the following steps:

(1) selecting a combination of two submerged plants;

(2) planting the combination of submerged plants;

(3) measuring a biomass and evaluating the biomass:

measuring a biomass of two submerged plants respectively, and calculating a relative yield of the species in mixed planting with a biomass of the species planted individually as reference, wherein a specific calculation method is as follows:

RY_{A}=Y_{AB}/(P_{A}×Y_{A}) \textcircled{1}

RY_{B}=Y_{BA}/(P_{B}×Y_{B}) \textcircled{2}

in the formula \textcircled{1}, RY_{A} represents the relative yield of species A, Y_{AB} represents the biomass of species A in mixed planting of A and B, Y_{A} represents the biomass of species A in single planting, and P_{A} represents the proportion of species A in mixed planting of A and B;

in the formula \textcircled{2}, RY_{B} represents the relative yield of species B, Y_{BA} represents the biomass of species B in mixed planting of A and B, Y_{B} represents the biomass of species B in single planting, and P_{B} represents the proportion of species B in mixed planting of A and B;

according to the calculated relative yields of species A and B, calculating the relative yield sum RYT of the two species in mixed planting, wherein a specific calculation method is as follows:

RYT=(RY_{A}+RY_{B})/2 \textcircled{3}

if RYT is equal to 1, the interaction between the two species is not obvious;

if RYT is greater than 1, there is a positive interaction between the two species;

if RYT is less than 1, there is a negative interaction competition between the two species.

To further optimize the technical scheme: the combination in step (1): species A is Potamogeton maackianus and species B is Myriophyllum verticillatum; the planting ratio of Myriophyllum verticillatum and Potamogeton maackianus is 1:3.

To further optimize the technical scheme: the step (2) of planting includes:

1) collecting two kinds of plant materials from natural lakes and selecting tips for reserve;

2) planting the tips of species A and B in each container in a crisscross manner;

3) setting three different water eutrophication gradients for planting and cultivation.

To further optimize the technical scheme:

laying a layer of pond mud with a thickness of 5.5 cm in the container in step 2), then inserting a lower end of the plant tip into a pond mud with a thickness of 3 cm, and laying a layer of cleaned river sand with a thickness of 2 cm on the pond mud after planting.

To further optimize the technical scheme: a planting density of both species is 130 plants/m².

To further optimize the technical scheme: three different water eutrophication gradients in step 3) are:

moderate eutrophy TN 2.0 mg L⁻¹, TP 0.5 mg L⁻¹;

heavy eutrophy TN 4.0 mg L⁻¹, TP 1.0 mg L⁻¹;

ultra eutrophy TN 8.0 mg L⁻¹, TP 2.0 L⁻¹.

### Embodiment 3

A method for planting submerged plants, including the following steps:

(1) selecting a combination of two submerged plants;

(2) planting the combination of submerged plants;

(3) measuring a biomass and evaluating the biomass:

measuring a biomass of two submerged plants respectively, and calculating a relative yield of the species in mixed planting with a biomass of the species planted individually as reference, wherein a specific calculation method is as follows:

RY_{A}=Y_{AB}/(P_{A}×Y_{A}) \textcircled{1}

RY_{B}=Y_{BA}/(P_{B}×Y_{B}) \textcircled{2}

in the formula \textcircled{1}, RY_{A} represents the relative yield of species A, YAB represents the biomass of species A in mixed planting of A and B, Y_{A} represents the biomass of species A in single planting, and P_{A} represents the proportion of species A in mixed planting of A and B;

in the formula \textcircled{2}, RY_{B} represents the relative yield of species B, YB_{A} represents the biomass of species B in mixed planting of A and B, Y_{B} represents the biomass of species B in single planting, and P_{B} represents the proportion of species B in mixed planting of A and B;

according to the calculated relative yields of species A and B, calculating the relative yield sum RYT of the two species in mixed planting, wherein a specific calculation method is as follows:

RYT=(RY_{A}+RY_{B})/2 \textcircled{3}

if RYT is equal to 1, the interaction between the two species is not obvious;

if RYT is greater than 1, there is a positive interaction between the two species;

if RYT is less than 1, there is a negative interaction competition between the two species.

To further optimize the technical scheme: the combination in step (1): species A is Potamogeton maackianus and species B is Myriophyllum verticillatum; the planting ratio of Myriophyllum verticillatum and Potamogeton maackianus is 1:3.

To further optimize the technical scheme: the step (2) of planting includes:

1) collecting two kinds of plant materials from natural lakes and selecting tips for reserve;

2) planting the tips of species A and B in each container in a crisscross manner;

3) setting three different water eutrophication gradients for planting and cultivation.

To further optimize the technical scheme:

laying a layer of pond mud with a thickness of 6 cm in the container in step 2), then inserting a lower end of the plant tip into a pond mud with a thickness of 3.2 cm, and laying a layer of cleaned river sand with a thickness of 2.2 cm on the pond mud after planting.

To further optimize the technical scheme: a planting density of both species is 130 plants/m².

To further optimize the technical scheme: three different water eutrophication gradients in step 3) are:

moderate eutrophy TN 2.0 mg L⁻¹, TP 0.5 mg L⁻¹;

heavy eutrophy TN 4.0 mg L⁻¹, TP 1.0 mg L⁻¹;

ultra eutrophy TN 8.0 mg L⁻¹, TP 2.0 L⁻¹.

### Comparative Experiment

(1) Selecting submerged plants species Myriophyllum verticillatum and Potamogeton microphyllum, which are common in freshwater lakes and ponds, have strong pollution resistance and can symbiotically reproduce asexually through the stem nodes.

(2) Collecting these two kinds of plant materials from natural lakes, and cultivating the experimental materials, wherein the length of each tip is 15 cm, and the tip of the plants should not be injured and flowering plants should not be selected.

(3) Using a series of substitution experiments, the planting proportions of five different species were constructed, followed by Myriophyllum verticillatum: Potamogeton maackianus=4:0, 3:1, 2:2, 1:3, 0:4.

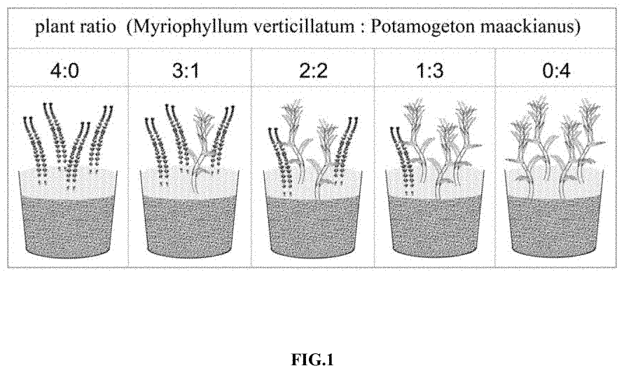

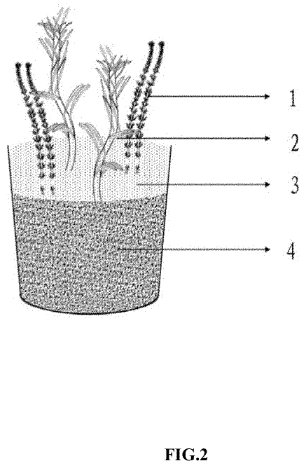

(4) Taking every two plant tips as one seedling, and planting four plants (cross planting) in each small bowl (12 cm in upper diameter, 10 cm in height and 700 ml in volume), namely planting two (tips)×four plants in each small pot, totally eight plant tips (FIG. 1).

(5) When planting plants, first laying a layer of pond mud with a thickness of about 6 cm at the bottom of the small bowl (pond sediment, mixed well before use), and then inserting a lower end of the plant tip into the pond mud for about 3 cm, and laying a layer of cleaned river sand with a thickness of 2 cm on the pond mud after planting.

(6) The plants are planted in small bowls, and then the small bowls are placed in black plastic vats (67 cm in upper diameter, 82 cm in height and 300 L in volume) for culture, with five small bowls in each vat, and the plants in the five small bowls are planted in exactly the same way. That is, two (tips)×4 plants×5 bowls were planted in each vat, and a total of 40 plant tips (20 tips of Myriophyllum verticillatum +20 tips of Potamogeton microphylla) were planted, and the planting density of the two species was 130 plants/m2.

(7) Setting three different water eutrophication gradients in the order of moderate eutrophy TN 2.0 mg L⁻¹, TP 0.5 mg L⁻¹, heavy eutrophy TN 4.0 mg L ⁻¹, TP 1.0 mg L i and ultra eutrophy TN 8.0 mg L⁻¹, TP 2.0 L ⁻¹, filling tap water into a black vat, adjusting the concentration of the culture solution to the preset concentration values of N and P by adding two nutrient solutions of NH₄NO₃ and K₂HPO₄ into the tap water.

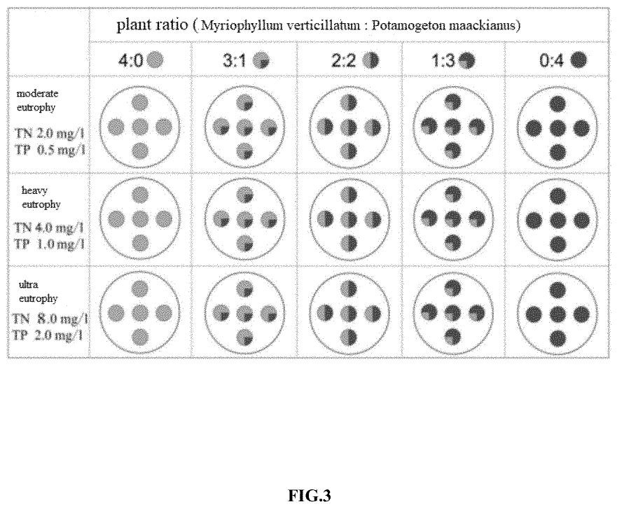

(8) Referring to step (3) to (6), planting submerged plants under three different nutrient gradients of moderate eutrophy, heavy eutrophy and ultra eutrophy, respectively (FIG. 3).

(9) Setting each group of gradients with three repetitions, and setting each gradient with five density ratios, that is, 3 (repetition)×3 (gradient)×5 (density ratio) with a total of 45 big barrels, and 45 (big barrels)×5 with a total of 225 small bowls; planting eight plant tips in each small pot, 225 (small bowl)×8 (tip) with a total of 2000 plant tips, 1,000 tips of Myriophyllum verticillatum and Potamogeton microphyllum each.

(10) The experimental period is 60 days. During the experiment, the medium was measured regularly and drugs were added in time. Wash containers regularly to prevent algae production.

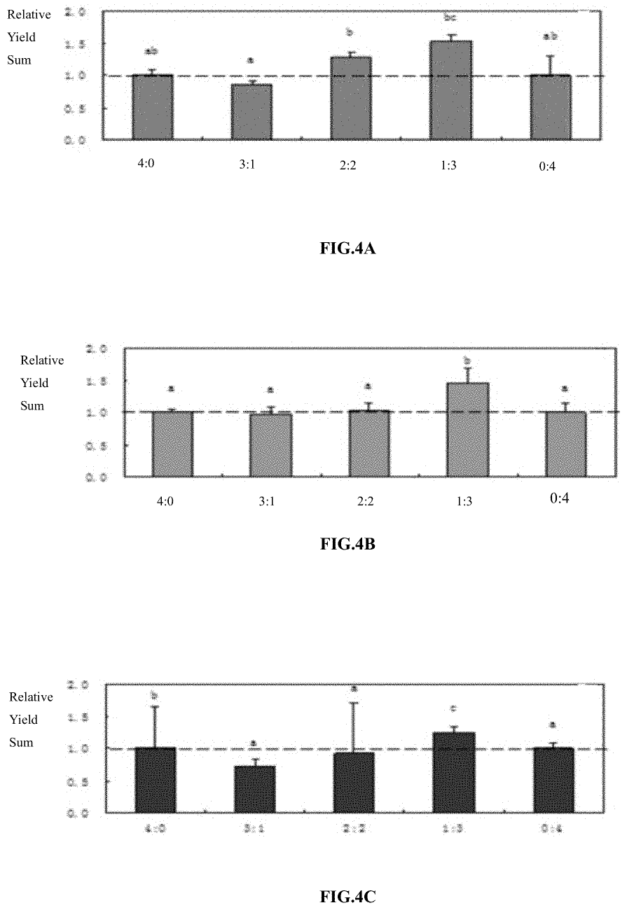

(11) After the experiment, collecting the submerged plants in the vat, measuring the biomass of the two submerged plants respectively, and calculating the relative yield, and getting the sum of the relative yields of the two species under different nutrient gradients, as shown in FIG. 4 below.

The results in FIG. 4 show that under different nutrient gradients, the total relative yield of the two species is significantly higher when the ratio of Myriophyllum verticillatum to Potamogeton maackianus is 1:3 than that of other planting ratios, that is, when the ratio of Myriophyllum verticillatum to Potamogeton maackianus is 1:3, the positive interaction between the two species is the largest, and it is the most conducive to the construction and growth of submerged plants community.

In summary, for the restoration and reconstruction of submerged plants in shallow lakes with different nutrient gradients, when the planting ratio of Myriophyllum verticillatum to Potamogeton microphylla is 1:3, the positive interaction between the two species is the largest, and the biomass of plant community is the highest, which is the most conducive to the construction and rapid growth of submerged plant community. The disclosure is beneficial to providing scientific theoretical basis for the restoration and reconstruction of submerged plants in shallow lakes.

In this specification, each embodiment is described in a progressive way, and each embodiment focuses on the differences from other embodiments, so it is enough to refer to the same and similar parts between each embodiment.

The above description of the disclosed embodiments enables those skilled in the art to realize or use the present disclosure. Many modifications to these embodiments will be obvious to those skilled in the art, and the general principles defined herein can be implemented in other embodiments without departing from the spirit or scope of the present disclosure. Therefore, the present disclosure will not be limited to the embodiments shown herein, but should be accorded the widest scope consistent with the principles and novel features disclosed herein.

What is claimed is:

1. A method for planting submerged plants, comprising the following steps:
(1) selecting a combination of two submerged plants;
(2) planting the combination of submerged plants;
(3) measuring a biomass and evaluating the biomass:
measuring a biomass of two submerged plants respectively, and calculating a relative yield of the species in mixed planting with a biomass of the species planted individually as reference, wherein a specific calculation method is as follows:
RY_{A}=Y_{AB}/(P_{A}'Y_{A}) \textcircled{1}
RY_{B}=Y_{BA}/(P_{B}×Y_{B}) \textcircled{2}
in the formula \textcircled{1}, RY_{A} represents the relative yield of species A, Y_{AB} represents the biomass of species A in mixed planting of A and B, Y_{A} represents the biomass of species A in single planting, and PA represents the proportion of species A in mixed planting of A and B;
in the formula \textcircled{2}, RY_{B} represents the relative yield of species B, Y_{BA} represents the biomass of species B in mixed planting of A and B, Y_{B} represents the biomass of species B in single planting, and P_{B} represents the proportion of species B in mixed planting of A and B;
according to the calculated relative yields of species A and B, calculating the relative yield sum RYT of the two species in mixed planting, wherein a specific calculation method is as follows:
RYT=(RY_{A}+RY_{B})/2 \textcircled{3}
if RYT is equal to 1, the interaction between the two species is not obvious;
if RYT is greater than 1, there is a positive interaction between the two species;
if RYT is less than 1, there is a negative interaction competition between the two species.

2. The method of claim 1, wherein the combination in step (1): species A is Potamogeton maackianus and species B is Myriophyllum verticillatum; the planting ratio of Myriophyllum verticillatum and Potamogeton maackianus is 1:3.

3. The method of claim 2, wherein the step (2) of planting comprises:
1) collecting two kinds of plant materials from natural lakes and selecting tips for reserve;
2) planting the tips of species A and B in each container in a crisscross manner;
3) setting three different water eutrophication gradients for planting and cultivation.

4. The method of claim 3, comprising: laying a layer of pond mud with a thickness of 5-6 cm in the container in step 2), then inserting a lower end of the plant tip into a pond mud with a thickness of 2.8˜3.2 cm, and laying a layer of cleaned river sand with a thickness of 1.8˜2.2 cm on the pond mud after planting.

5. The method of claim 4, wherein a planting density of both species is 130 plants/m².

6. The method of claim 4, wherein three different water eutrophication gradients in step 3) are:
moderate eutrophy TN 2.0 mg L⁻¹, TP 0.5 mg L⁻¹;
heavy eutrophy TN 4.0 mg L⁻¹, TP 1.0 mg L ⁻¹;
ultra eutrophy TN 8.0 mg L⁻¹, TP 2.0 L⁻¹.

7. An application of the method of claim 1 in restoration and reconstruction of submerged plants in shallow lakes.
